(19) United States
(12) Patent Application Publication
(10) Pub. No.: US 2022/0312731 A1
(43) Pub. Date: Oct. 6, 2022

(54) Removable garment for an animal

(71) Applicants: DoYoung Lim, Los Angeles, CA (US); Yeu Hoon Yun, Los Angeles, CA (US)

(72) Inventors: DoYoung Lim, Los Angeles, CA (US); Yeu Hoon Yun, Los Angeles, CA (US)

(21) Appl. No.: 17/219,651

(22) Filed: Mar. 31, 2021

(51) Int. Cl. A01K 13/00; A01K 27/00

(52) U.S. Cl. CPC A01K 13/006; A01K 27/002

(57) ABSTRACT

A removable garment for an animal is presented. The removable garment has two parts: a base unit and a covering unit. The covering unit is larger than the base unit, and it is easily attached to and detached from the base unit.

An improved version of the removable garment has three parts: a base unit, a covering unit, and an alternate covering unit. The alternate covering unit is to be used interchangeably with the covering unit; that is, the alternate covering unit is used instead of the covering unit and interacts with the base unit.

The removable garment may be used anytime and specially designed to protect the pet from environmental hazards, protecting the pet from rain, cold weather, etc.

### SUMMARY

A removable garment for an animal is presented herein. When walking an animal or having the animal play freely, a removable garment is desired so that a cover (or a covering garment) may be easily put on or removed from the pet without removing a pet clothing to protect the pet against the environmental hazard, including but not limited to, rain, mud, cold or heat.

Today, there are many pets in the United States, and the care for such pets is becoming more popular. Many pets, especially dogs and even cats are walked by the owners and sometimes by professional dog walkers. There are even pet foods advertising as gourmet pet food. There are even pet vitamins and pet water marketed today. Thus, the care given to pets is becoming increasingly more personal.

In such pet-loving culture, the garments for pets have been pretty much the same: a single piece of garment (clothing) put on a pet. Some of these pet garments cover only a small portion of the pet's back, and some of these garments cover a large portion of the pet's body. Thus, when a pet garment is put on an animal, such as a dog, for an outdoor outing (such as a walk around a neighborhood), the pet garment is put on, and the pet is taken out. Once outside, if the environment changes rapidly or the owner had misestimated the conditions, the pet garment is unchangeable to adjust to the environmental conditions, such as a sudden rain. All the pet owner could do is take off the garment and make the pet bare or put on a different garment (assuming the pet owner had carried a second garment). Thus, there is a need to have a removable garment for an animal, a pet, a dog that can easily have an outer garment (“a covering unit”) be removably attachable and detachable to an inner garment (“a base unit”), so the base unit does not need to be taken off. Such a removable garment for an animal is presented herein.

A removable garment for an animal has a base unit (“an inner garment” or “an inner unit”) removably attachable to the animal. The base unit has a body wrap with two leg holes into which two front legs of the animal are inserted through. In addition to the base unit, the removable garment has a covering unit (“an outer garment” or “an outer unit”) that is larger than the base unit. The covering unit is removably attachable to the base unit by attaching means, including but not limited to a hook and pile system (Velcro®), insertable clips, buckles, or quick-release rotational buckles as shown in FIGS. 2-4 and 6-7.

The body wrap has a first flap and a second flap. The first flap is removably attached to the second flap to hold the base unit securely attached to the animal by an attaching means, including but not limited to a hook and pile system (Velcro®), insertable clips, or buckles. For simplicity, a hook and pile system may be preferred.

The base unit may be a garment with a base harness or simply a base harness with no additional garment attached to the base harness. Either way, the base harness has one or more base-harness ends. A single base-harness end may be used to removably attached to the covering unit with a cover-attaching point. When the base unit has a plurality of base-harness ends and the cover unit has a matching plurality of cover-attaching points, each base-harness end removably attaching to its respective cover-attaching point will hold the covering unit securely held by the base unit.

When the removable garment is put on the animal, the base harness is placed on (or under) an underside of the animal so that the base-harness end may be lifted to point toward the upper back of the animal. The first flap and the second flap also point toward the upper back of the animal, such that the first flap removably attaches to the second flap. At least one of the first flap or the second flap covers a portion of the upper back of the animal.

The covering unit has an outer side and an inner side. The inner side has a cover-attaching point that is used to removably attach to the base-harness end, securely holding the removable garment on the animal. The covering unit also has a leash-attaching point on the outer side. The leash-attaching point may be used to removably attach a leash or a string or other restraining device to restrain and better control the animal.

The covering unit also has a neck portion and a hood that extends from the neck portion. The hood may extend out to cover the head of the animal. Such cover may be a stiff or a soft cover over the head to prevent rain from hitting the head of the animal, keeping the head dry. It is also possible that the hood is shaped as a cap that can be fitted and put on the head of the pet to better protect its head. It is recommended that the hood is made of a transparent material or a translucent material so the mater may see the head of the pet through the hood while the hood protects the pet's head and eyes.

The covering unit may also have a hood-string attached to the hood so that the hood-string is used to adjust the extension of the hood from the neck portion by pulling on the hood. Such a hood-string may be pulled (drawn) so that the hood retracts into a pocket near the neck portion. Alternately, the hood may be made of substantially elastic material, such as a see-through vinyl, that can be folded or retracted into the pocket. Considering the removable garment may be ideally used to prevent water (or other debris) and other environmental conditions, the covering unit and the hood are made of water repellent, water-resistant material, or water-impervious material. So, the covering unit may be made of any material used to make human garments, especially for protecting against rain, chemical, and other environmental hazards.

An improvement to the removable garment will be to have three main parts: a base unit, a covering unit, and an alternate-covering unit to be used instead of the covering unit. The removable garment for an animal may be used comfortably with only the base unit and the covering unit; However, such a large covering unit may not be preferable all the time. For example, the ambient temperature is not too cold, and it is sunny. In such time, a simple much smaller alternate-covering unit may be used to keep the animal cool without a much large covering unit. The pet's master can easily carry the covering unit in a bag.

An improved system having three main parts for the removable garment is described as follows. The removable garment for an animal has a base unit removably attachable to the animal. The base unit has a body wrap with two leg holes (or more to accommodate all four legs) through which two front legs (or four legs) of the animal are inserted when the animal wears the base unit. The body wrap has a first flap and a second flap so that the first flap is easily removably attached to the second flap.

The base unit has a base harness having a plurality of base-harness ends. The base harness is placed on or under the underside of the animal. The plurality of base-harness ends point is toward the upper back of the animal, and the first flap and the second flap also point toward the upper back of the animal. The first flap removably attaches to the second flap. At least some parts of the first flap or the second flap cover a portion of the animal's upper back. The upper back of the animal herein is described to include any part of the animal above its rib cage.

The removable garment for an animal also has a covering unit that is larger than the base unit and removably attachable to the base unit. The covering unit has an outer side and an inner side. The covering unit also has a plurality of cover-attaching points located on the inner side. The cover unit may be removably attached to the base unit, by each of the respective plurality of cover-attaching points removably attached to each of the respective plurality of base-harness ends.

The removable garment for an animal also has a leash-attaching point on the outer side of the covering unit and the covering unit has a neck portion. A hood is attached to the neck portion and maybe extended over from the neck portion to cover the animal's head.

The removable garment for an animal also has an alternate covering unit that is smaller than the covering unit. The alternate covering unit has a plurality of alternate-attaching points, such that the alternative covering unit may be used instead of the covering unit when the covering unit is unnecessary.

The alternate covering unit may attach to the base unit when each of the respective plurality of alternate-attaching points is removably attached to each of the respective plurality of base-harness ends.

As described earlier, the covering unit may have a hood-string attached to the hood so that the hood-string is used to adjust the extension of the hood from the neck portion. In this configuration, if the neck portion has a pocket, the hood can be inserted (or pulled into) the pocket. For better viewing of the pet, the hood should be made of a transparent or translucent material.

To simplify the alternate covering, especially for the times a large covering is not needed, the alternate covering unit may be a simple substitute harness, formed into a simple harness to removably attached to one or more base-harness ends. When multiple alternate-attaching points are used, two of the plurality of alternate-attaching points may be connected to a middle portion of the substitute harness, forming a shape of the letter “Y” with the middle portion. These two alternate-attaching points are to be placed towards the head of the animal. Besides the two alternate-attaching points used, two different alternate-attaching points may be connected to the middle portion of the substitute harness, forming a shape of the upside-down letter “T” with the middle portion. These two different alternate-attaching points are to be placed towards the tail of the animal. As with the covering unit, the substitute harness shall have an alternate leash-attaching point so a leash may be easily connected.

Various versions of the removable garment are available. For example, the covering unit may have a hood-cover to cover the hood or the animal's head. The hood-cover covers the head when the hood is retracted into the pocket and protects the hood when desired.

A removable garment for an animal is presented, and it is better described, together with the drawings and detailed description below.

### BRIEF DESCRIPTION OF THE DRAWINGS

These and other features, aspects, and advantages of the removable garment for an animal will become better understood with reference to the accompanying drawings, wherein:

FIG. 1: the removable garment for an animal as worn by a pet,

FIG. 2: the base unit of the removable garment,

FIG. 3: the covering unit of the removable garment,

FIG. 4: the inner side of the covering unit of the removable garment,

FIG. 5: the outer side of the covering unit of the removable garment,

FIG. 6: the alternate covering unit of the removable garment, and

FIG. 7: the alternate covering unit, instead of the covering unit, worn by the pet.

### DETAILED DESCRIPTION

A removable garment 10 for an animal 15 is described in Figs.

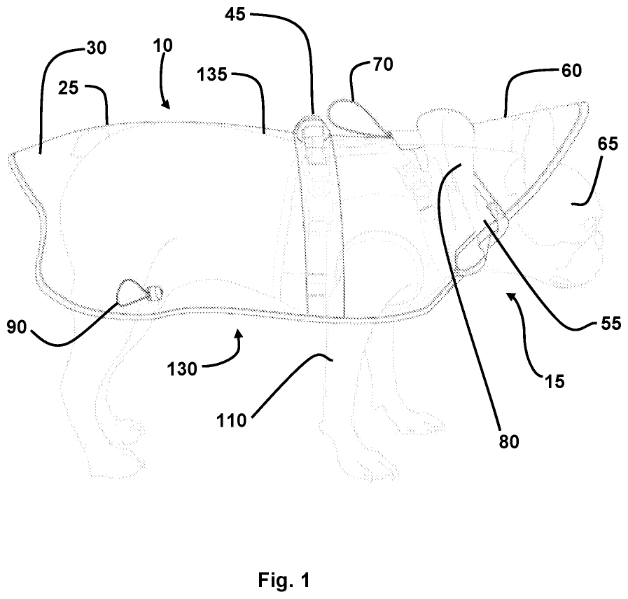

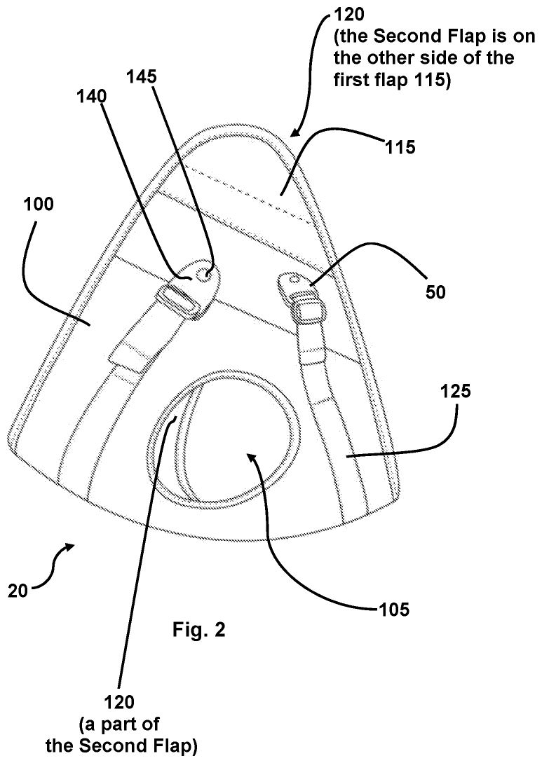

FIG. 1 shows the removable garment 10 for an animal 15 as worn by a pet, a dog. As shown in FIGS. 1 and 2, the removable garment 10 has two parts: a base unit 20 and a covering unit 25.

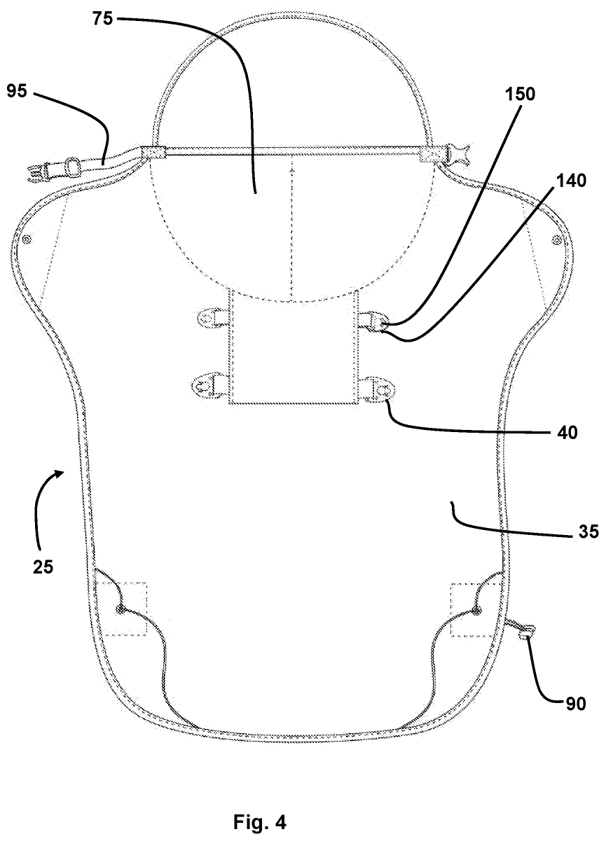

The covering unit 25, as shown in FIGS. 1, 3, and 4, has an outer side 30 and an inner side 35 (shown in FIG. 4) and a cover-attaching point 40 (shown in FIG. 4). FIG. 1 also shows one or more leash-attaching points 45. The cover-attaching point 40 located on the inner side 35 is removably attachable to the base-harness end 50 (shown in FIG. 2), securely holding the removable garment 10 on the animal.

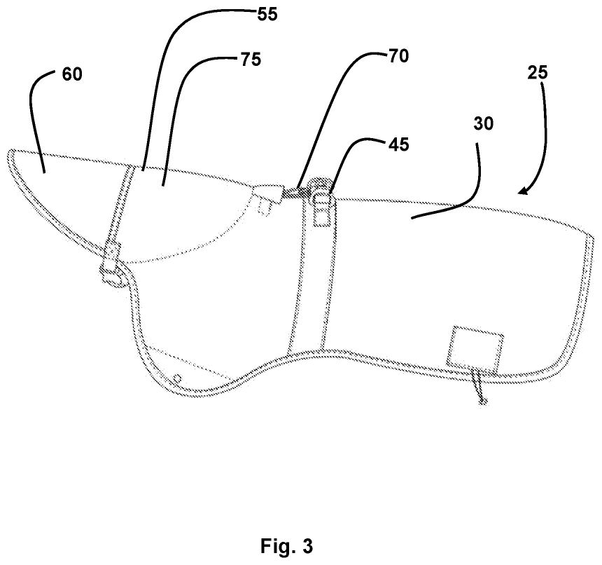

The covering unit 25 has a neck portion 55 and a hood 60 that extends from the neck portion 55 and extends over to cover a head 65 of the animal when the covering unit 25 is worn by the animal. The covering unit 25 may also have a hood-string 70 attached to the hood 60, and the hood-string 70 is used to adjust the extension of the hood 60 from the neck portion 55 by pulling on the hood 60. In addition, the covering unit 25 can also have a pocket 75 (shown in FIGS. 3-4) openable and closeable near or on the neck portion 55 so that the hood 60 may be inserted into the pocket 75.

As an optional improvement, the covering unit 25 may also have a hood-cover 80 that can be extended to cover the hood 70 or the head 65 of the animal 15. The hood-cover 80 covers the head 65 when the hood 60 is retracted into the pocket 75, and the hood-cover 80 protects over the hood 60 when desired. Moreover, when the hood-cover 80 is not needed, the hood-cover 80 may be rolled up and placed near the neck portion 55 as shown. Although not shown, it is possible to have a bag attached to the covering unit 25 or a second pocket placed on the covering unit 25

The covering unit 25 may also have a hood-string 70 attached to the hood 60, and the hood-string 70 is used to adjust the extension of the hood 60 from the neck portion 55 by pulling on the hood 60 to retract into the pocket 75. The hood 60 can be held and pulled out of the pocket 75.

In addition, the covering unit 25 may also have a fitting string 90 (also shown in FIG. 4) to adjust the fitting of the covering unit 25 on the animal 15. Moreover, the covering unit 25 may also have a neckband 95 on the neck portion 55 to securely place the covering unit around the neck of the animal.

FIG. 2 shows the base unit 20 removably attachable to the animal 15. The base unit 20 has a body wrap 100 having two leg holes 105 into which two front legs 110 of the animal are inserted through when worn. The body wrap 100 has a first flap 115 and a second flap 120 (partially shown; the second flap 120 is on the other side of the first flap 115) so that the first flap 115 is removably attached to the second flap 120 to hold the base unit 20 securely attached to the animal 15.

The base unit 20, as shown, has a base harness 125 having a base-harness end 50. The base harness 125 is placed on an underside 130 (belly side) of the animal 15 when worn so that the base-harness end 50 points toward an upper back 135 of the animal and that the first flap 115 and the second flap 120 also point toward the upper back 135 of the animal such that the first flap 115 removably attaches to the second flap 120 and at least one of the first flap 115 or the second flap 120 covers a portion of the upper back 135 of the animal.

The covering unit 25 may be removably attached to the base unit by various attaching means, including but not limited to a hook and pile system (Velcro®), insertable and releasable clips, buckles, or a quick-release rotational buckle system 140. Each of the covering means described and commonly known in the industry may be used to attach or removably attach any part of the removable garment 10.

A sample of the quick-release rotational buckle system 140 is shown in FIGS. 2-4 and 6-7. A quick-release rotational buckle system 140 has one end with a protrusion 145 that is inserted into the matching end with a hole 150, which is shaped like an “8” or a snowman (as in two circles slightly overlapping) with one of the circles smaller than the other. A sample of a quick-release rotational buckle system 140 is shown in FIG. 2 and FIG. 4, showing a combination of the base-harness end 50 having a protrusion 145 that is to be inserted into a hole 150 in the cover attaching point 40 that is shaped like an “8” or a snowman with one of the circles smaller than the other.

An improved version of the removable garment 10 has three parts: a base unit 20, a covering unit 25, and an alternate covering unit 155. The alternate covering unit 155 is to be used interchangeably with the covering unit 25; that is, the alternate covering unit 155 is used instead of the covering unit 25 when desired and interacts with the base unit 20. In this improved version, the base unit 20 and the covering unit 25 are about the same as the above-described version.

The covering unit 25, as shown in FIGS. 1, 3, and 5, has an outer side 30 and an inner side 35 (shown in FIG. 4) and a plurality of cover-attaching points 40 (shown in FIG. 4). FIG. 1 also shows one or more leash-attaching points 45. The plurality of cover-attaching points 40 located on the inner side 35 is removably attachable to a plurality of base-harness ends 50 (shown in FIG. 2), securely holding the removable garment 10 on the animal.

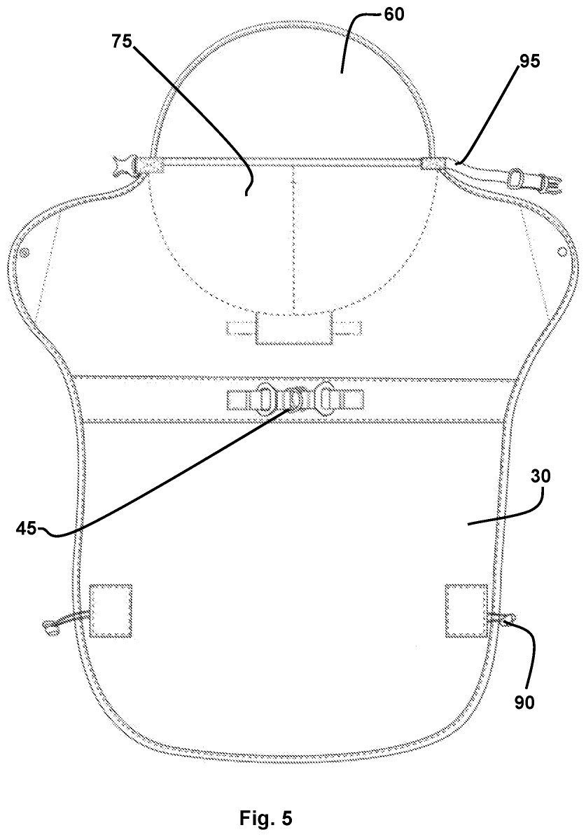

As shown in FIG. 1 and FIG. 5, the covering unit 25 has a neck portion 55 and a hood 60 that extends from the neck portion 55 and extends over to cover the head 65 of the animal when the covering unit 25 is worn by the animal. The covering unit 25 may also have a hood-string 70 attached to the hood 60, and the hood-string 70 is used to adjust the extension of the hood 60 from the neck portion 55 by pulling on the hood 60. Also, the covering unit 25 can also have a pocket 75 (shown in FIGS. 3-4) openable and closeable near or on the neck portion 55 so that the hood 60 may be inserted into the pocket 75.

As an optional improvement, the covering unit 25 may also have a hood-cover 80 covering the hood 60 or the head 65 of the animal 15. The hood-cover 80 covers the head 65 when the hood 60 retract into the pocket 75, and the hood-cover 80 protects over the hood 60 when desired. Moreover, when the hood-cover 80 is not needed, the hood-cover 80 may be rolled and placed near the neck portion 55 as shown.

The covering unit 25 may also have a hood-string 70 attached to the hood 60, and the hood-string 70 is used to adjust the extension of the hood 60 from the neck portion 55 by pulling on the hood 60 to retract into the pocket 75. In addition, the covering unit 25 may also have a fitting string 90 to adjust the fitting of the covering unit 25 on the animal 15. Moreover, the covering unit 25 may also have a neckband 95 on the neck portion 55 to securely place the covering unit around the animal's neck.

FIG. 2 shows the base unit 20 removably attachable to the animal 15. The base unit 20 has a body wrap 100 having two leg holes 105 into which two front legs 110 of the animal are inserted through. The body wrap 100 has a first flap 115 and a second flap 120 (partially shown; the second flap 120 is on the other side of the first flap 115) so that the first flap 115 is removably attached to the second flap 120 to hold the base unit 20 securely attached to the animal 15.

The base unit 20, as shown in FIG. 2, has a base harness 125 having the plurality of base-harness ends 50. The base harness 125 is placed on an underside 130 (belly side) of the animal 15 when worn so that the plurality of base-harness ends 50 points toward an upper back 135 of the animal and that the first flap 115 and the second flap 120 also point toward the upper back 135 of the animal such that the first flap 115 removably attaches to the second flap 120 and at least one of the first flap 115 or the second flap 120 covers a portion of the upper back 135 of the animal.

FIG. 4 shows the inner side 35. The inner side 35 has a plurality of cover attaching point 40 to engage the configuration of the base-harness ends 50 to securely and removably attaching the covering unit 25 with the base unit 20. FIG. 4 also shows the fitting string 90 as it is laid out on the covering unit 25. FIG. 5 shows the outer side 30, showing the neckband 95 and the leash-attaching point for a leash to be attached. The fitting string 90, as shown, may be pulled to tighten the covering unit 25 snuggly around the pet.

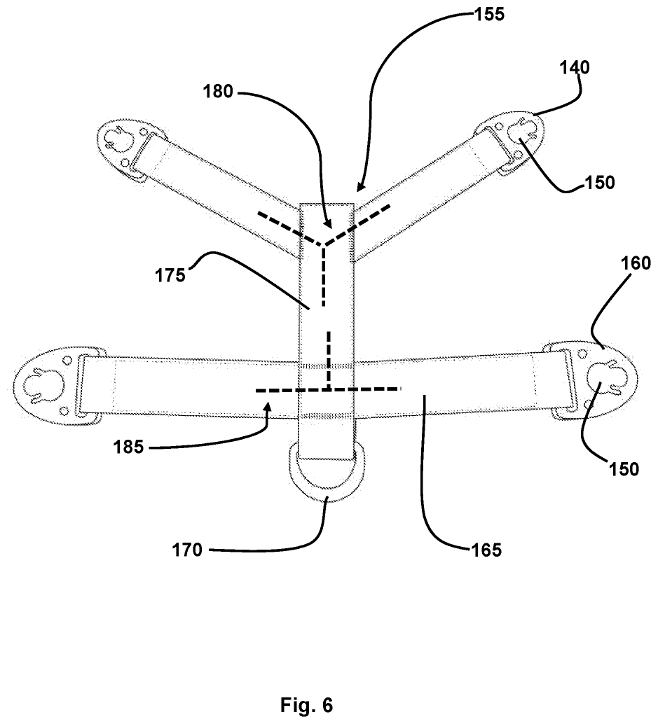

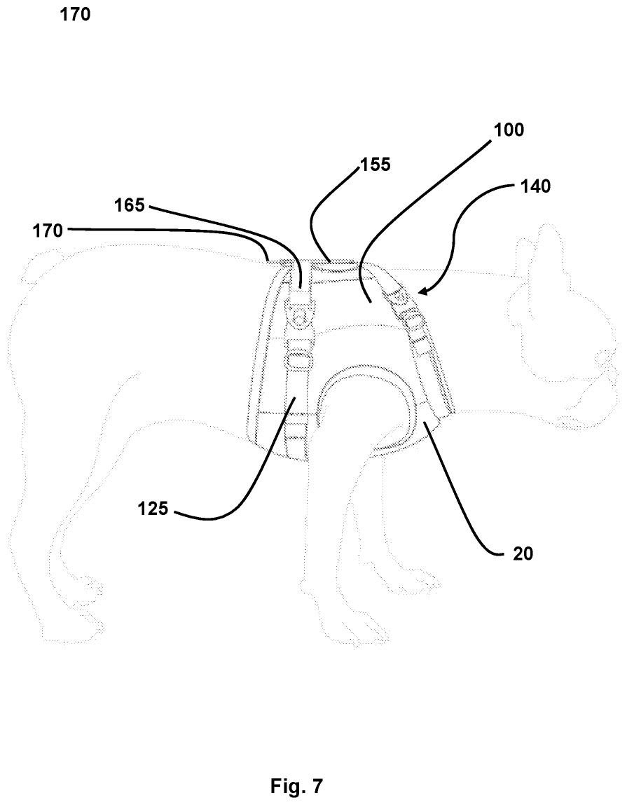

AS shown in FIGS. 6 and 7, the third part of this improved version of the removable garment 10 is shown: the alternate covering unit 155. The alternate covering unit 155 is interchangeable with the covering unit 25; that is, the alternate covering unit 155 is used instead of the covering unit 25 and interacts with the base unit 20.

The alternate covering unit 155 is smaller than the covering unit 25 and has a plurality of alternate-attaching points 160, and the alternate covering unit 155 is to be used instead of the covering unit 25 when the large covering provided by the covering unit 25 is undesired. The alternate covering unit 155 therefore attaches to the base unit 20 with each of the respective plurality of alternate-attaching points 160 removably engaging and attaching to each of the respective plurality of base-harness ends 50.

As shown in FIG. 6, the alternate covering unit 155 may be quite simple in design, and it may be a simple substitute harness 165 that has no fabric or other covering parts attached to the substitute harness 165. It should be noted that although the alternate covering unit 155, as shown, does not have a fabric or different covering materials but the use of such a fabric or different covering materials is possible. The alternate covering unit 155 has one or more alternate leash-attaching points 170 so that a leash, a string, or other pet devices may be easily attached.

A preferred version of the substitute harness 165 is shown in FIG. 6. Two of the plurality of alternate-attaching points 160 are connected to a middle portion 175 of the substitute harness 165 forming a shape of letter “Y” (as shown by the broken lines, 180) with the middle portion 175, and these two alternate-attaching points 160 are to be placed towards the head 65 of the animal when worn. In addition, two different alternate-attaching points 160 are connected to the middle portion 175 of the substitute harness 165 forming a shape of the upside-down letter “T” (as shown by the broken lines, 185) with the middle portion 165 at the opposite end and these two different alternate-attaching points 160 are to be placed towards a tail of the animal when worn.

A large covering unit 25 may not be preferred at all times, and a much smaller and simple alternate covering unit 155, such as the substitute harness 165, may be desired. For example, the weather may be sunny and warm. In such a time, a simple much smaller alternate-covering unit 155 may be used to keep the animal 15 cool without a much larger covering unit 25 on the animal. A simple substitute harness 165 can be used with the base unit 20. However, when the weather quickly changes or better protecting the pet from the environment is desired, the pet owner can quickly take off the alternate-covering unit 155 and easily put on a much larger covering unit 25 that the pet owner inconspicuously carries.

While the description, drawings, and references have presented, shown, and described with reference to different embodiments thereof, it will be appreciated by those skilled in the art that variations in form, detail, compositions, and operation may be made without departing from the spirit and scope of the disclosure. For example, the covering unit may have two or more holes (not shown) for the legs of the animals to be inserted through for custom fit.

What is claimed is:

1. A removable garment for an animal comprising:
a base unit removably attachable to the animal comprising a body wrap having two leg holes into which two front legs of the animal are inserted through, and
a covering unit that is larger than the base unit and removably attachable to the base unit.

2. The removable garment for an animal of claim 1 wherein the body wrap further comprises of a first flap and a second flap, and wherein the first flap is removably attached to the second flap to hold the base unit securely worn by the animal.

3. The removable garment for an animal of claim 2 wherein the covering unit is removably attached to the base unit using a quick-release rotational buckle system.

4. The removable garment for an animal of claim 2 wherein the base unit comprises of a base harness having a base-harness end.

5. The removable garment for an animal of claim 4 wherein the base harness is placed on an underside of the animal when worn so the base-harness end points toward an upper back of the animal and that the first flap and the second flap also point toward the upper back of the animal such that the first flap removably attaches to the second flap and at least one of the first flap or the second flap covers a portion of the upper back of the animal.

6. The removable garment for an animal of claim 5 wherein the covering unit comprises of an outer side and an inner side, and a cover-attaching point.

7. The removable garment for an animal of claim 6 wherein the cover-attaching point is located on the inner side and the cover-attaching point is removably attached to the base-harness end, securely holding the removable garment on the animal.

8. The removable garment for an animal of claim 7 wherein the outer side of the covering unit comprises of a leash-attaching point.

9. The removable garment for an animal of claim 8 wherein the covering unit further comprises of a neck portion and a hood that extends from the neck portion and extends over to cover a head of the animal when the covering unit is worn by the animal.

10. The removable garment for an animal of claim 9 wherein the hood is made of a transparent material, and the covering unit and the hood are made of water repellent or water-resistant material.

11. The removable garment for an animal of claim 10 wherein the covering unit further comprises of a hood-string attached to the hood, and the hood-string is used to adjust the extension of the hood from the neck portion by pulling on the hood.

12. The removable garment for an animal of claim 11 wherein the neck portion has a pocket wherein the hood is insertable into the pocket.

13. The removable garment for an animal of claim 12 wherein the covering unit further comprises of a hood-cover to cover the hood or the head of the animal.

14. A removable garment for an animal comprising:
a base unit removably attachable to the animal, wherein the base unit comprises of a body wrap having two leg holes through which two front legs of the animal are inserted when the base unit is worn by the animal, wherein the body wrap further comprises of a first flap and a second flap, and wherein the base unit further comprises of a base harness having a plurality of base-harness ends, wherein the base harness is placed on an underside of the animal when worn so that the plurality of base-harness ends point toward an upper back of the animal, and that the first flap and the second flap also point toward the upper back of the animal so that the first flap removably attaches to the second flap,
a covering unit that is removably attachable to the base unit, wherein the covering unit comprises of an outer side, an inner side, and a plurality of cover-attaching points located on the inner side so that the cover unit is removably attached to the base unit by each of the respective plurality of cover-attaching points removably attaching to each of the respective plurality of base-harness ends, and the covering unit further comprises of a neck portion and a hood that extends from the neck portion to cover a head of the animal, and
an alternate covering unit, to be used instead of the covering unit when the covering unit is not desired, wherein the alternate covering unit is smaller than the covering unit and having a plurality of alternate-attaching points so that the alternate covering unit attaches to the base unit when each of the respective plurality of alternate-attaching points is removably attached to each of the respective plurality of base-harness ends.

15. The removable garment for an animal of claim 14 wherein the covering unit further comprises of a hood-string attached to the hood such that the hood-string is used to adjust the extension of the hood from the neck portion.

16. The removable garment for an animal of claim 15 wherein the neck portion has a pocket, wherein the hood may be inserted into the pocket.

17. The removable garment for an animal of claim 16 wherein the hood is made of a transparent material, and wherein the covering unit and the hood are made of water repellent or water-resistant material, and wherein the outer side of the covering unit comprises of a leash-attaching point.

18. The removable garment for an animal of claim 17 wherein the covering unit further comprises of a hood-cover to cover the hood or the head of the animal.

19. The removable garment for an animal of claim 18 wherein the alternate covering unit is a substitute harness.

20. The removable garment for an animal of claim 19 wherein two of the plurality of alternate-attaching points are connected to a middle portion of the substitute harness forming a shape of letter “Y” with the middle portion, and these two alternate-attaching points are to be placed towards the head of the animal when worn, and wherein two different alternate-attaching points are connected to the middle portion of the substitute harness forming a shape of an upside-down letter “T” with the middle portion and these two different alternate-attaching points are to be placed towards a tail of the animal when worn, and wherein the substitute harness further comprises of an alternate leash-attaching point.
